(19) United States
(12) Patent Application Publication
(10) Pub. No.: US 2015/0146285 A1
(43) Pub. Date: May 28, 2015

(54) REFLECTIVE STRUCTURE FOR OPTICAL TOUCH SENSING

(71) Applicant: UNIMICRON TECHNOLOGY CORP., Taoyuan (TW)

(72) Inventors: Ming-Huei Yang, Taipei City (TW); Tsung-Dar Cheng, Taipei City (TW); Ping-Chen Chen, Taipei City (TW); Yu-Ling Hsu, Taipei City (TW)

(73) Assignee: UNIMICRON TECHNOLOGY CORP., Taoyuan (TW)

(21) Appl. No.: 14/172,874

(22) Filed: Feb. 4, 2014

(30) Foreign Application Priority Data
Nov. 28, 2013 (TW) 102143498

(51) Int. Cl. G02B 27/14; G02B 1/10

(52) U.S. Cl. CPC G02B 27/14; G02B 1/105
USPC 359/359; 359/629

(57) ABSTRACT

A reflective structure for optical touch sensing, which includes a transparent substrate, a plurality of microstructures and a transmittive reflective layer. The transparent substrate has a surface. The microstructures are disposed on the transparent substrate and expose a portion of the surface to allow a visible light to pass through. The transmittive reflective layer is disposed on the microstructures and at least covers a portion of the microstructures.

### CROSS-REFERENCE TO RELATED APPLICATION

This application claims the priority benefit of Taiwan application serial no. 102143498, filed on Nov. 28, 2013. The entirety of the above-mentioned patent application is hereby incorporated by reference herein and made a part of this specification.

### BACKGROUND OF THE INVENTION

1. Field of the Invention

The invention relates a reflective structure, and more particularly, to a reflective structure for optical touch sensing.

2. Description of Related Art

In conventional art, an optical touch sensing structure is usually composed of a light color paper base material and a plurality of black ink patterns printed on the light color paper base material. When an infrared light emitted by a light pen is irradiated on the optical touch sensing structure, the black ink patterns may absorb the infrared light, and the light color paper base material may reflect and scatter the infrared light. The infrared light being reflected or scattered may then be detected by an infrared light camera disposed in the light pen, thereby forming an infrared light image corresponding to the black ink patterns. When the light pen contacts the optical touch sensing structure and moves across a surface of the optical touch sensing structure, a processor may determine positions of a contact point and movements of the touch point according to a variation of the infrared light image captured by the infrared light camera.

Since the light color paper base material includes a rough surface, the infrared light generated by the light pen may be reflected and scattered towards multiple directions, thus the infrared light camera is prone to capture a reflected image. In other words, signals regarding the positions of the touch point may still be read even when the light pen is tilted at an overly huge angle. However, the light color paper base material itself is not transparent (i.e. it is not light-transmittable), thus such optical touch sensing structure cannot be widely used in common display. Further, even if a light-transmittable effect is accomplished by using an extra thin light color paper base material, in addition to reflect and scatter the infrared light, the light color paper base material may also reflect and scatter light emitted by the display and environmental light, which causes the image to get foggy, thereby further reducing the image contrast and resolution.

### SUMMARY OF THE INVENTION

The invention is directed to a reflective structure for optical touch sensing, capable of reflecting the infrared light through a transmittive reflective layer at least covering a portion of microstructures. Meanwhile, the transmittive reflective layer includes a nature of light transmittance for replacing above-said paper base material. Furthermore, the existing black ink patterns may be replaced if the transmittive reflective layer is patterned, such that the invention may directly provide an optical touch sensing structure without using the black ink patterns.

The invention provides a reflective structure for optical touch sensing, which includes a transparent substrate, a plurality of microstructures and a transmittive reflective layer. The transparent substrate has a surface. The microstructures are disposed on the transparent substrate, and the microstructures expose a portion of the surface to allow a visible light to pass through, so that overall light transmittance of the visible light of the reflective structure for optical touch sensing may be improved. The transmittive reflective layer is disposed on the microstructures and at least covers a portion of the microstructures. When an infrared light is incident to the microstructures, the portion of the microstructures may reflect the infrared light through the transmittive reflective layer. Since the transmittive reflective layer is extra thin, the visible light is able to partially pass through, and the overall light transmittance of the visible light of the reflective structure for optical touch sensing may also be improved.

In an embodiment of the invention, a refractive index of the microstructures is identical or similar to a refractive index of the transparent substrate.

In an embodiment of the invention, the microstructures and the transparent substrate are integrally formed.

In an embodiment of the invention, a shape of an orthographic projection of each of the microstructures on the substrate includes a circular shape, an elliptical shape, or a polygonal shape.

In an embodiment of the invention, the microstructures are disposed on the surface of the transparent substrate, the microstructures are arranged in an array or a non-array, and a graphic formed by the array comprises a circular shape or a polygonal shape.

In an embodiment of the invention, the microstructures are relatively recessed to the surface of the transparent substrate, the microstructures are arranged in an array or a non-array, and a graphic formed by the array comprises a circular shape or a polygonal shape.

In an embodiment of the invention, a thickness of the transmittive reflective layer is less than or equal to 40 nanometers.

In an embodiment of the invention, the transmittive reflective layer completely covers surfaces of the microstructures.

In an embodiment of the invention, when an infrared light is incident to a portion of the microstructures covered by the transmittive reflective layer, the portion of the microstructures reflects the infrared light through the transmittive reflective layer.

In an embodiment of the invention, when the infrared light is incident to another portion of the microstructures not covered by the transmittive reflective layer, the portion of the microstructures scatters the infrared light.

In an embodiment of the invention, the transmittive reflective layer is a single-layer reflective layer or a multi-layer reflective layer.

In an embodiment of the invention, the reflective structure for optical touch sensing further includes a transparent protective layer covering the portion of the surface of the transparent substrate exposed by the microstructures, the microstructures, and the transmittive reflective layer.

In an embodiment of the invention, a refractive index of the transparent protective layer is between a refractive index of air and a refractive index of the transmittive reflective layer.

In an embodiment of the invention, the reflective structure for optical touch sensing further includes a plurality of optical absorption portions disposed on the transparent protective layer and exposing a portion of the transparent protective layer.

In an embodiment of the invention, a width of each of the microstructures is between 10 μm to 100 μm.

In an embodiment of the invention, a height of each of the microstructures is between 5 μm to 50 μm.

Based on above, the reflective structure for optical touch sensing of the invention includes the transparent substrate, the microstructures and the transmittive reflective layer. Accordingly, when the infrared light emitted by the touch sensing element (i.e., the optical stylus) emits is irradiated on the reflective structure for optical touch sensing, the surface of the transparent substrate exposed by the microstructures may allow the visible light to pass through, and the microstructures covered by the transmittive reflective layer may reflect the infrared light through the transmittive reflective layer to the infrared light camera in the touch sensing element, so that the positions of the touch point may be deduced. Moreover, when the reflective structure for optical touch sensing is subsequently installed in, for example, a common display (e.g., a liquid-crystal display, a cathode ray tube display or a plasma display), the transparent substrate thereof may be configured to allow most of light from the display to pass through, and prevent the image from getting foggy. Therefore, the reflective structure for optical touch sensing of the invention may include a wider range of application.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1A is a schematic sectional view of a reflective structure for optical touch sensing according to an embodiment of the invention.

FIG. 1B to FIG. 1E are partial top views illustrating microstructures of the reflective structure for optical touch sensing depicted in FIG. 1A.

FIG. 2 is a schematic sectional view of a reflective structure for optical touch sensing according to another embodiment of the invention.

FIG. 3 is a schematic sectional view of a reflective structure for optical touch sensing according to another embodiment of the invention.

FIG. 4A is a schematic sectional view of a reflective structure for optical touch sensing according to another embodiment of the invention.

FIG. 4B is a schematic 3D diagram of one single microstructure of the reflective structure for optical touch sensing depicted in FIG. 4A.

FIG. 5 is a schematic sectional view of an optical touch sensing structure composed of a reflective structure for optical touch sensing of the invention together with optical absorption portions.

### DESCRIPTION OF THE EMBODIMENTS

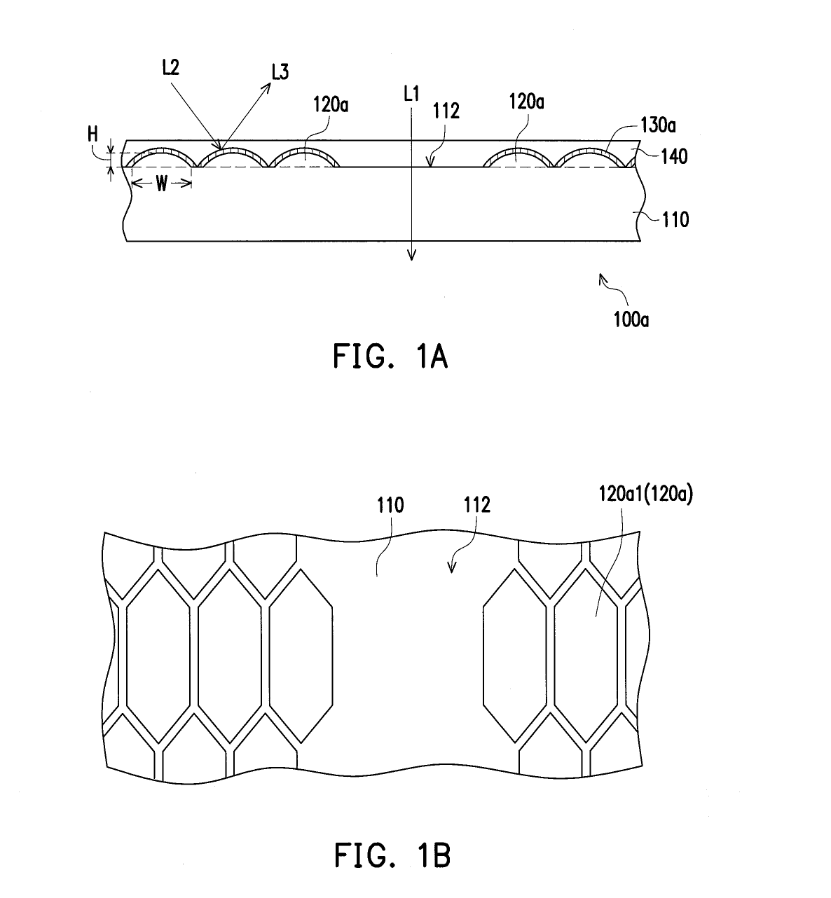

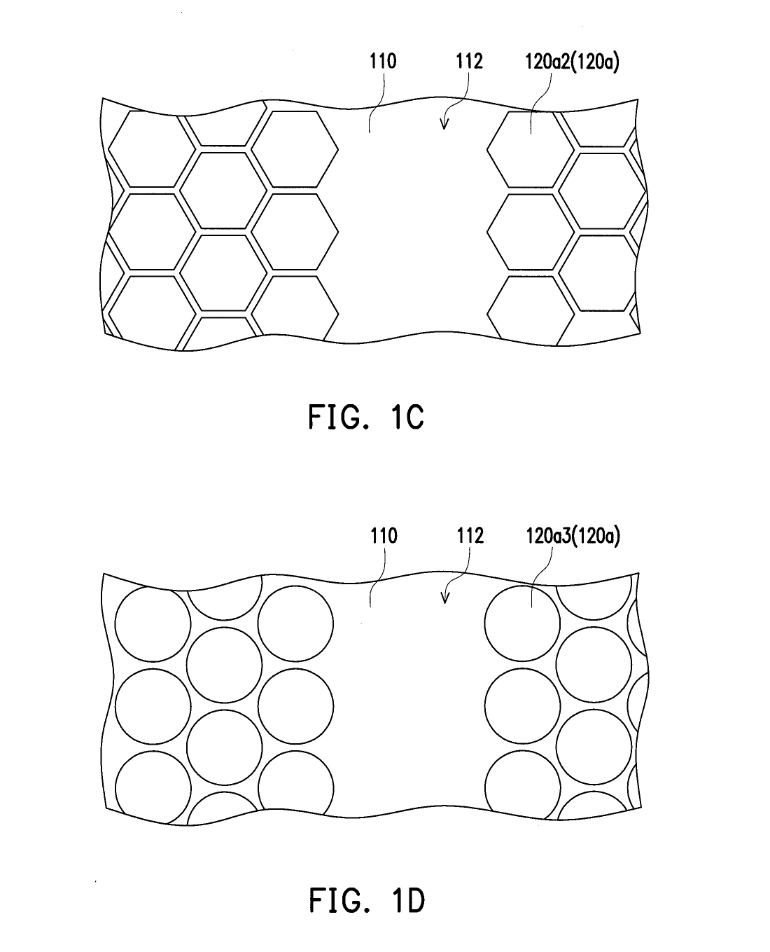

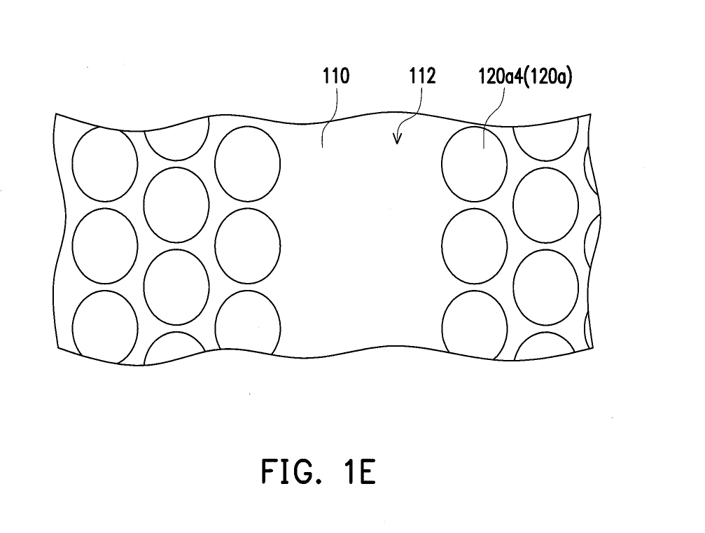

FIG. 1A is a schematic sectional view of a reflective structure for optical touch sensing according to an embodiment of the invention. FIG. 1B to FIG. 1E are partial top views illustrating microstructures of the reflective structure for optical touch sensing depicted in FIG. 1A. Referring to FIG. 1A, in the present embodiment, a reflective structure for optical touch sensing 100a includes a transparent substrate 110, a plurality of microstructures 120a and a transmittive reflective layer 130a. The transparent substrate 110 has a surface 112. The microstructures 120a are disposed on the transparent substrate 110, and the microstructures 120a expose a portion of the surface 112 to allow a visible light L1 to pass through. The transmittive reflective layer 130a is disposed on the microstructures 120a and at least covers a portion of the microstructures 120a. When an infrared light L2 is incident to the microstructures 120a, the portion of the microstructures 120a may reflect the infrared light L2 through the transmittive reflective layer 130a into a reflected infrared light L3. Practically, since the incident infrared light L2 is a light beam having a width and the microstructures 120a includes characteristics of geometrical shapes, the reflected infrared light L3 may be reflected towards multiple directions. Therefore, although it is not clearly illustrated in FIG. 1A, a portion of the reflected infrared light L3 is reflected towards to an incidence direction of the infrared light L2, thereby creating a returning reflective effect. Therefore, when the infrared light camera (not illustrated) is disposed next to the an infrared light source (not illustrated), it works the same as common light pens, such that even if the incidence direction of the infrared light L2 is changed, the infrared light camera may still capture the reflected infrared light L3. In other words, regardless of whether the light pen is vertical to the transparent substrate 110 or is tilted at an overly huge angle, a reflective image of the infrared light may still be captured.

More specifically, a material of the transparent substrate 110 of the present embodiment is, for example, a glass, a plastic, a polymethylmethacrylate (PMMA), or other materials with high light transmittance. More preferably, the microstructures 120a and the transparent substrate 110 are seamlessly connected. Namely, the microstructures 120a and the transparent substrate 110 are integrally formed, and a refractive index of the microstructures 120a is identical to a refractive index of the transparent substrate 110. Of course, in other embodiments not illustrated, the microstructures 120a and the transparent substrate 110 may also be two structures separated from each other, but the refractive index of the microstructures 120a must be identical or similar to the refractive index of the transparent substrate 110. Said embodiment still belongs to a technical means adoptable in the present invention and falls within the protection scope of the invention. Herein, as shown in FIG. 1A, in view of the sectional view, the microstructures 120a of the present embodiment are of arc shapes.

More specifically, referring to FIG. 1B, a shape of an orthographic projection of each of microstructures 120a1 on the transparent substrate 110 is a polygonal shape, such as a hexagon; or, referring to FIG. 1C, a shape of an orthographic projection of each of the microstructures 120a2 on the transparent substrate 110 is a regular hexagon; or, referring to FIG. 1D, a shape of an orthographic projection of each of the microstructures 120a3 on the transparent substrate 110 is a circular shape; or, referring to FIG. 1E, a shape of an orthographic projection of each of the microstructures 120a4 on the transparent substrate 110 is an elliptical shape, or other appropriate shapes.

The shapes of orthographic projections of the microstructures 120a1 to 120a4 on the transparent substrate 110 belong to a technical means adoptable in the present invention and falls within the protection scope of the invention. Generally, a width of conventional black ink patterns is substantially 100 μm. Accordingly, it is more preferable that each of the microstructures 120a as a replacement to the conventional black ink patterns includes a width no more 100 μm, so as to avoid an excessive optical scattering phenomenon. Further, it is also more preferable that each of the microstructures 120a includes an aspect ratio which is not overly big, so as to facilitate in manufacturing the transmittive reflective layer 130a while avoiding the excessive optical scattering phenomenon. Herein, the aspect ratio of each of the microstructures 120a is set to no more than ½. More preferably, a width W of each of the microstructures 120a is between 10 μm to 100 μm, and a height H of each of the microstructures 120a is between 5 μm and μm 50 μm.

As shown in FIG. 1A, the microstructures 120a are disposed on the surface 112 of the transparent substrate 110. Herein, the surface 112 of the transparent substrate 110 is substantially a flat surface. The microstructures 120a are arranged in an array or a non-array, and expose said flat surface (i.e., the surface 112). Therein, in case they are arranged in the array, a graphic formed by the array may be, for example, a circular shape or a polygonal shape, but the invention is not limited thereto. The transmittive reflective layer 130a completely covers surfaces of the microstructures 120a, thus when the infrared light L2 is incident to the microstructures 120a, the microstructures 120a may reflect the infrared light L2 (i.e., the infrared light L3 in FIG. 1A) through the transmittive reflective layer 130a covered thereon. More preferably, a thickness of the transmittive reflective layer 130a is less than or equal to 40 nanometers, so that a capability of reflecting the infrared light L2 may also be provided in addition to a capability of light transmittance. It should be noted that, although the transmittive reflective layer 130a illustrated in FIG. 1A is substantially a single-layer reflective layer, but the transmittive reflective layer may also be a multi-layer in other embodiments not illustrated. Said embodiment still belongs to a technical means adoptable in the present invention and falls within the protection scope of the invention.

Further, a reflective structure for optical touch sensing 100a may further includes a transparent protective layer 140, and the transparent protective layer 140 covers the portion of the surface 112 of the transparent substrate 110 exposed by the microstructures 120a, the microstructures 120a, and the transmittive reflective layer 130a. More preferably, a refractive index of the transparent protective layer 140 is between a refractive index of air and a refractive index of the transmittive reflective layer 130a (e.g., the refractive index is between 1 and 2), so that overall light transmittance of the visible light L1 of the reflective structure for optical touch sensing 100a may be improved.

In the present embodiment, the surfaces of microstructures 120a disposed on the transparent substrate 110 are completely covered by the transmittive reflective layer 130a, and the transmittive reflective layer 130a has a strong effect in reflecting the infrared light L2, while the transparent substrate 110 has a weaker effect in reflecting the infrared light L2. Therefore, when the infrared light L2 emitted by a touch sensing element (e.g., an optical stylus, not illustrated) is irradiated on the reflective structure for optical touch sensing 100a, the surface 112 of the transparent substrate 110 exposed by the microstructures 120a may allow the visible light L1 to pass through. The microstructures 120a covered by the transmittive reflective layer 130a may reflect the infrared light L2 through the transmittive reflective layer 130a to the infrared light camera in the touch sensing element for replacing an infrared light reflection function originally included by a light color paper base material. The visible light L1 may directly pass through the transparent protective layer 140 and the transparent substrate 110. Therefore, when the reflective structure for optical touch sensing 100a is installed in, for example, a display (not illustrated), in addition to serve as an effective reflector for the infrared light L2, the transparent substrate 110 thereof may be configured to effectively sustain the light transmittance of the display and reduce the image from getting foggy. Therefore, the reflective structure for optical touch sensing 100a of the present embodiment may include a wider range of application.

It should be noted that the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

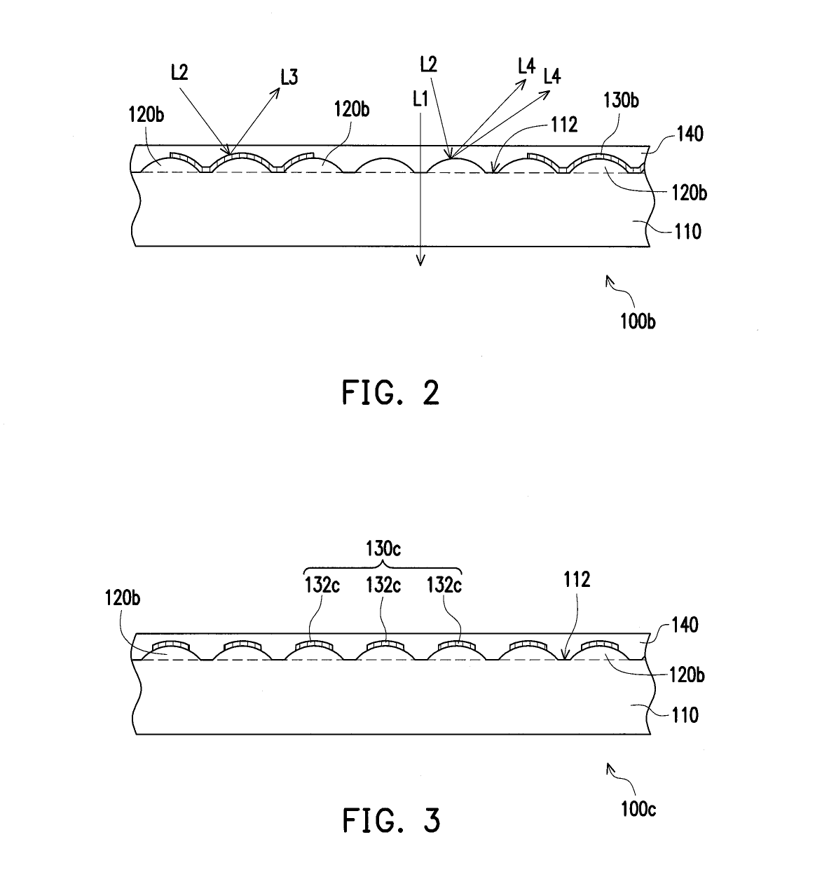

FIG. 2 is a schematic sectional view of a reflective structure for optical touch sensing according to another embodiment of the invention. Referring to FIG. 2, a reflective structure for optical touch sensing 100b of the present embodiment is similar to the reflective structure for optical touch sensing 100a of FIG. 1A, and a major difference between the two is that: in the present embodiment, microstructures 120b are not completed covered by a transmittive reflective layer 130b of the reflective structure for optical touch sensing 100b, and the microstructures 120b disposed on the surface 112 of the transparent substrate 110 are arranged in an array and expose a portion of the surface 112. More specifically, a transmittive reflective layer 130b only directly covers a portion of the microstructures 130b and the surface 112 of the transparent substrate 110 between the microstructures 120b covered by the transmittive reflective layer 130b. In other words, the transmittive reflective layer 130b exposes another portion of the microstructures 120b. Therefore, when the infrared light L2 is incident to the microstructures 120b, the portion of the microstructures 120b covered by the transmittive reflective layer 130b may reflect the infrared light L2 (the infrared light L3 in FIG. 2) through the transmittive reflective layer 130b, and another portion of the microstructures 120b not covered by the transmittive reflective layer 130b may scatter the infrared light L2 (i.e., an infrared light L4 in FIG. 2).

The transmittive reflective layer 130b of the present embodiment may be referred to as a patterned transmittive reflective layer capable of replacing the conventional black ink patterns and forming infrared light reflective patterns. Accordingly, the reflective structure for optical touch sensing 100b may directly become an optical touch sensing structure without using the black ink patterns, so that overall visible light transmittance may also be improved.

FIG. 3 is a schematic sectional view of a reflective structure for optical touch sensing according to another embodiment of the invention. Referring to FIG. 3, a reflective structure for optical touch sensing 100c of the present embodiment is similar to the reflective structure for optical touch sensing 100b of FIG. 2, and a major difference between the two is that: in the present embodiment, a transmittive reflective layer 130c of the reflective structure for optical touch sensing 100c is composed of a plurality of transmittive reflective patterns 132c, and the transmittive reflective patterns 132c are respectively disposed on the microstructures 120b without connecting to one another. As shown in FIG. 3, the transmittive reflective patterns 132c are located on arc-shaped top surfaces of the microstructures 120b.

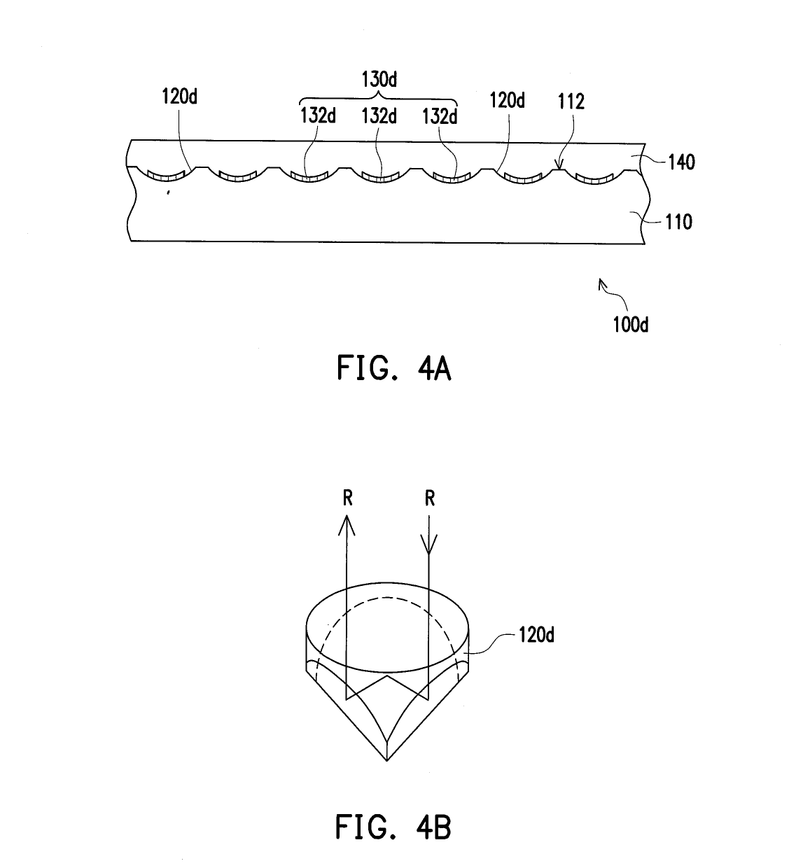

FIG. 4A is a schematic sectional view of a reflective structure for optical touch sensing according to another embodiment of the invention. FIG. 4B is a schematic 3D diagram of one single microstructure of the reflective structure for optical touch sensing depicted in FIG. 4A. Referring to FIG. 4A, a reflective structure for optical touch sensing 100d of the present embodiment is similar to the reflective structure for optical touch sensing 100c of FIG. 3, and a major difference between the two is that: in the present embodiment, microstructures 120d of the reflective structure for optical touch sensing 100d are relatively recessed to the surface 112 of the transparent substrate 110, and the microstructures 120d are arranged in an array or a non-array and expose a portion of the surface 112. Therein, in case they are arranged in the array, a graphic formed by the array may be, for example, a circular shape or a polygonal shape, but the invention is not limited thereto. Transmittive reflective patterns 132d of the transmittive reflective layer 130d are respectively disposed on the microstructures 120d without connecting to one another. As shown in FIG. 4A, the transmittive reflective patterns 132d are located on arc-shaped recess surfaces of the microstructures 120d.

More specifically, referring to FIG. 4B, each of the microstructures 120d is a depressed corner cube which is a structure composed of three planes perpendicular to one another, so that an incident light ray R may be reflected for three times before going back in their original directions thereby creating the returning reflective effect. Therefore, when the infrared light camera (not illustrated) is disposed next to the an infrared light source (not illustrated), it works the same as common light pens, such that even if the incidence direction of the infrared light (the infrared light L2 in FIG. 2) is changed, the infrared light camera may still capture the reflected infrared light (the infrared light L3 in FIG. 2). In other words, regardless of whether the light pen is vertical to the transparent substrate 110 or is tilted at an overly huge angle, a reflective image of the infrared light may still be captured.

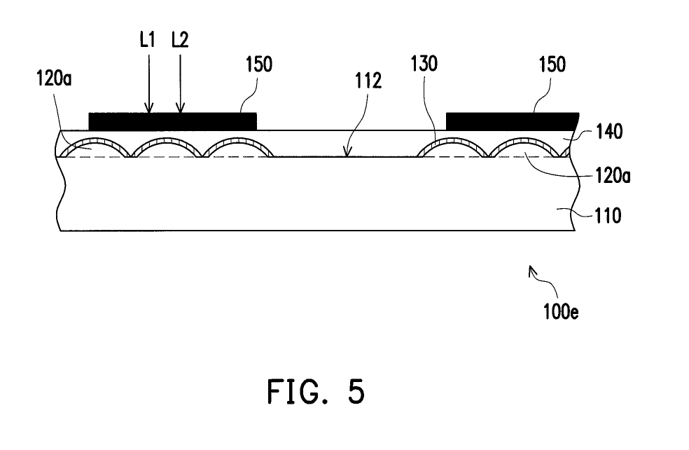

FIG. 5 is a schematic sectional view of a reflective structure for optical touch sensing according to another embodiment of the invention. Referring to FIG. 5, a reflective structure for optical touch sensing 100e of the present embodiment is similar to the reflective structure for optical touch sensing 100a of FIG. 1A, and a major difference between the two is that: in the present embodiment, the reflective structure for optical touch sensing 100e further includes a plurality of optical absorption portions 150, and the optical absorption portions 150 are disposed on the transparent protective layer 140 and exposes a portion of the transparent protective layer 140. Herein, the optical absorption portions 150 may be referred to as dark spots not reflecting the visible light and the infrared light, and a material thereof is, for example, a black ink. However, the invention is not limited thereto. When the infrared light L2 emitted by the touch sensing element (e.g., the optical stylus, not illustrated) is irradiated on the reflective structure for optical touch sensing 100e, the visible light L1 and the infrared light L2 may both be absorbed by the optical absorption portions 150, such that the infrared light L2 may create a relatively greater difference in the reflective indexes on the reflective structure for optical touch sensing 100e. Accordingly, when the reflective structure for optical touch sensing 100e is subsequently installed in, for example, a display (not illustrated), in addition to serve as an effective reflector for the infrared light L2, the light transmittance of the display may be effectively sustained and the image from getting foggy may also be reduced. Therefore, the reflective structure for optical touch sensing 100e of the present embodiment may include a wider range of application.

In summary, the reflective structure for optical touch sensing of the invention includes the transparent substrate, the microstructures and the transmittive reflective layer. Accordingly, when the infrared light emitted by the touch sensing element (i.e., the optical stylus) emits is irradiated on the reflective structure for optical touch sensing, the surface of the transparent substrate exposed by the microstructures may allow the visible light to pass through, and the microstructures covered by the transmittive reflective layer may reflect the infrared light through the transmittive reflective layer to the infrared light camera in the touch sensing element, so that the positions of the touch point may be deduced. Moreover, when the reflective structure for optical touch sensing is subsequently installed in, for example, a common display (e.g, a liquid-crystal display, a cathode ray tube display or a plasma display), the transparent substrate thereof may be configured to allow most of light from the display to pass through, and prevent the image from getting foggy. Therefore, the reflective structure for optical touch sensing of the invention may include a wider range of application.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A reflective structure for optical touch sensing, comprising:
a transparent substrate having a surface;
a plurality of microstructures disposed on the transparent substrate, wherein the microstructures expose a portion of the surface to allow a visible light to pass through; and
a transmittive reflective layer disposed on the microstructures and at least covering a portion of the microstructures.

2. The reflective structure for optical touch sensing as recited in claim 1, wherein a refractive index of the microstructures is identical or similar to a refractive index of the transparent substrate.

3. The reflective structure for optical touch sensing as recited in claim 1, wherein the microstructures and the transparent substrate are integrally formed.

4. The reflective structure for optical touch sensing as recited in claim 1, wherein a shape of an orthographic projection of each of the microstructures on the substrate comprises a circular shape, an elliptical shape, or a polygonal shape.

5. The reflective structure for optical touch sensing as recited in claim 1, wherein the microstructures are disposed on the surface of the transparent substrate, the microstructures are arranged in an array or a non-array, and a graphic formed by the array comprises a circular shape or a polygonal shape.

6. The reflective structure for optical touch sensing as recited in claim 1, wherein the microstructures are relatively recessed to the surface of the transparent substrate, the microstructures are arranged in an array or a non-array, and a graphic formed by the array comprises a circular shape or a polygonal shape.

7. The reflective structure for optical touch sensing as recited in claim 1, wherein a thickness of the transmittive reflective layer is less than or equal to 40 nanometers.

8. The reflective structure for optical touch sensing as recited in claim 1, wherein the transmittive reflective layer completely covers surfaces of the micro structures.

9. The reflective structure for optical touch sensing as recited in claim 1, wherein when an infrared light is incident to a portion of the microstructures covered by the transmittive reflective layer, the portion of the microstructures reflects the infrared light through the transmittive reflective layer.

10. The reflective structure for optical touch sensing as recited in claim 9, wherein when the infrared light is incident to another portion of the microstructures not covered by the transmittive reflective layer, the another portion of the microstructures scatters the infrared light.

11. The reflective structure for optical touch sensing as recited in claim 1, wherein the transmittive reflective layer is a single-layer reflective layer or a multi-layer reflective layer.

12. The reflective structure for optical touch sensing of claim 1, further comprising:
a transparent protective layer covering the portion of the surface of the transparent substrate exposed by the microstructures, the microstructures, and the transmittive reflective layer.

13. The reflective structure for optical touch sensing as recited in claim 12, wherein a refractive index of the transparent protective layer is between a refractive index of air and a refractive index of the transmittive reflective layer.

14. The reflective structure for optical touch sensing as recited in claim 12, further comprising:
a plurality of optical absorption portions disposed on the transparent protective layer and exposing a portion of the transparent protective layer.

15. The reflective structure for optical touch sensing as recited in claim 1, wherein a width of each of the microstructures is between 10 μm to 100 μm.

16. The reflective structure for optical touch sensing as recited in claim 1, wherein a height of each of the microstructures is between 5 μm to 50 μm.
